(19) United States
(12) Patent Application Publication
(10) Pub. No.: US 2021/0159545 A1
(43) Pub. Date: May 27, 2021

(54) NON-AQUEOUS ELECTROLYTE SECONDARY BATTERY

(71) Applicant: SANYO Electric Co., Ltd., Daito-shi, Osaka (JP)

(72) Inventors: Takaaki Oka, Osaka (JP); Kei Kobayashi, Osaka (JP); Atsushi Mizawa, Hyogo (JP)

(73) Assignee: SANYO Electric Co., Ltd., Daito-shi, Osaka (JP)

(21) Appl. No.: 16/493,566

(22) PCT Filed: Mar. 8, 2018
(86) PCT No.: PCT/JP2018/008928

§ 371 Date: Sep. 12, 2019

(30) Foreign Application Priority Data
Mar. 16, 2017 (JP) 2017-051468

(51) Int. Cl. H01M 10/0587; H01M 4/133; H01M 4/134

(52) U.S. Cl. CPC H01M 10/0587; H01M 2004/027; H01M 4/134; H01M 4/133

(57) ABSTRACT

A non-aqueous electrolyte secondary battery including an electrode body in which a positive electrode plate including a belt-shaped positive electrode current collector and a positive electrode active material layer formed on a surface of the positive electrode current collector and a negative electrode plate including a belt-shaped negative electrode current collector and a negative electrode active material layer formed on a surface of the negative electrode current collector are wound with an insulating separator interposed there between. At the outermost periphery of the electrode body, a negative electrode current collector exposed portion, in which the negative electrode current collector is exposed, is provided, and a winding-finish end of the negative electrode plate is fixed with tapes attached to the negative electrode current collector exposed portion.

### TECHNICAL FIELD

The present disclosure relates to a non-aqueous electrolyte secondary battery.

### BACKGROUND ART

PTL 1 describes an electrode group for a non-aqueous secondary battery formed by spirally winding a belt-shaped positive electrode plate and a belt-shaped negative electrode plate with a separator interposed therebetween, in which an end of the separator wound around the outermost periphery of the electrode group is fixed with a tape by winding the tape around the peripheral surface of the electrode group by at least one or more turns. PTL 1 describes that, in this configuration, when the electrode group is inserted into a battery can, since the tape is wound around the peripheral surface of the electrode group by one or more turns, it is possible to prevent the separator from being turned up or torn and prevent active material layers of the electrode plates from falling off.

### CITATION LIST

### Patent Literature

PTL 1: Japanese Published Unexamined Patent Application No. 2009-19974

### SUMMARY OF INVENTION

### Technical Problem

There is a case where an electrode body formed by spirally winding a positive electrode plate and a negative electrode plate with a separator interposed therebetween is placed in a battery can made of metal, and the battery can is used as a negative electrode terminal. In this case, a negative electrode lead is often connected to a winding-finish end portion of the electrode body. In order to connect the negative electrode lead, a negative electrode current collector exposed portion, in which a negative electrode current collector, for example, formed of copper foil or the like is exposed, is provided at the winding-finish end portion of the negative electrode plate. In the case where the battery can serves as a negative electrode terminal, instead of the separator, the negative electrode current collector exposed portion can be arranged at the outermost periphery of the electrode body. By bringing the negative electrode current collector exposed portion into contact with the inner surface of the battery can, a negative electrode lead may be omitted in some cases.

In the case where the winding-finish end is fixed by attaching a tape to the negative electrode current collector exposed portion arranged at the outermost periphery, when charging and discharging are repeated, because of an increase in the diameter of the electrode body due to expansion of the active material layer during charging, stress intensively acts on the negative electrode active material layer of the negative electrode plate located on the inner peripheral side at a position corresponding to an edge of the tape. As a result, there is a concern that cracking may occur in the negative electrode active material layer, and because of exposure of the negative electrode current collector at the cracked portion, metallic lithium may be precipitated. Such a problem is likely to surface when a silicon compound, which is highly expandable and contractible, is used as a negative electrode active material in order to increase the capacity of the secondary battery.

It is an object of the present disclosure to provide an electrode body including a positive electrode plate and a negative electrode plate wound with a separator interposed therebetween, when a winding-finish end is fixed with a tape attached to a negative electrode current collector exposed portion, cracking of a negative electrode active material layer at a position corresponding to an edge of the tape can be suppressed.

### Solution to Problem

A non-aqueous electrolyte secondary battery according to the present disclosure includes an electrode body in which a positive electrode plate including a belt-shaped positive electrode current collector and a positive electrode active material layer formed on a surface of the positive electrode current collector and a negative electrode plate including a belt-shaped negative electrode current collector and a negative electrode active material layer formed on a surface of the negative electrode current collector are wound with an insulating separator interposed therebetween. At the outermost periphery of the electrode body, a negative electrode current collector exposed portion, in which the negative electrode current collector is exposed, is provided, and a winding-finish end of the negative electrode plate is fixed with tapes attached to the negative electrode current collector exposed portion. Each of the tapes is attached to a region located within 14% of the length in the axial direction of the negative electrode plate from a corresponding one of the two ends in the axial direction of the negative electrode plate.

### Advantageous Effects of Invention

In the non-aqueous electrolyte secondary battery according to the present disclosure, at each end portion in the axial direction of the electrode body, a tape is attached to a region located within 14% from the corresponding end in the axial direction of the negative electrode plate, and therefore, it is possible to suppress cracking of the negative electrode active material layer at a position corresponding to a tape edge on the central side in the axial direction.

### BRIEF DESCRIPTION OF DRAWINGS

FIG. 1 is a cross-sectional view of a non-aqueous electrolyte secondary battery according to an embodiment.

FIG. 2 is a perspective view of a wound type electrode body of the non-aqueous electrolyte secondary battery shown in FIG. 1.

FIG. 3 is a front view showing a positive electrode plate and a negative electrode plate constituting an electrode body, each in an unwound state.

FIG. 4 is a cross-sectional view in the radial direction showing the state in which an electrode body is fixed with a tape.

FIG. 5 is an enlarged cross-sectional view of a tape.

FIG. 6(a) is a perspective view of an electrode body, and FIG. 6(b) is a diagram showing a winding-finish end of a negative electrode plate and tapes, each in an unwound state.

FIG. 7 is an enlarged cross-sectional view of a tape fixed portion in an electrode body received inside a case main body.

FIG. 8 includes a perspective view and a diagram, similar to FIG. 6, showing an electrode body in which inner edges of tapes are arranged closer to ends in the axial direction of the electrode body than those of FIG. 6.

FIG. 9 includes a perspective view and a diagram, similar to FIG. 6, showing an electrode body in which inner edges of tapes are arranged closer to the central portion in the axial direction of the electrode body than those of FIG. 6.

### DESCRIPTION OF EMBODIMENTS

Embodiments of the present invention will be described in detail below with reference to the accompanying drawings. In the description, the specific shapes, materials, numeric values, directions, and the like are merely examples to facilitate understanding of the present invention, and may be changed as appropriate according to the use, objective, specifications, or the like. Furthermore, regarding the term “approximately” used hereinafter, for example, “approximately the same” means not only “completely the same” but also “substantially the same”. Moreover, when the description includes a plurality of embodiments, modified examples, and the like, it is originally assumed that the characteristic portions thereof are used in appropriate combination.

A non-aqueous electrolyte secondary battery 10 which is a cylindrical battery including a cylindrical case made of metal will be described below as an example. However, the non-aqueous electrolyte secondary battery according to the present disclosure is not limited thereto. The non-aqueous electrolyte secondary battery according to the present disclosure may be, for example, a prismatic battery including a prismatic case made of metal.

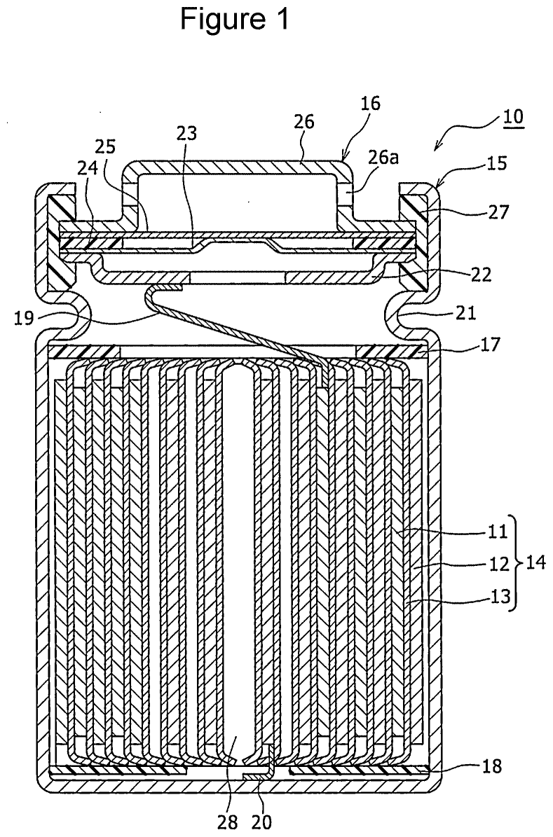

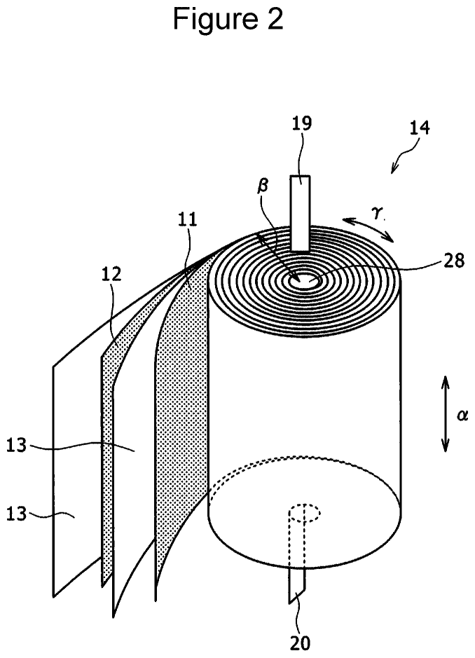

FIG. 1 is a cross-sectional view of a non-aqueous electrolyte secondary battery 10. FIG. 2 is a perspective view of an electrode body 14 constituting the non-aqueous electrolyte secondary battery 10. As illustrated in FIGS. 1 and 2, the non-aqueous electrolyte secondary battery 10 includes a wound type electrode body 14 and a non-aqueous electrolyte (not shown). The wound type electrode body 14 includes a positive electrode plate 11, a negative electrode plate 12, and a separator 13, and the positive electrode plate 11 and the negative electrode plate 12 are spirally wound with the separator 13 interposed therebetween. Hereinafter, one side in the axial direction of the electrode body 14 may be referred to as “the upper side”, and the other side in the axial direction may be referred to as “the lower side” in some cases. The non-aqueous electrolyte includes a non-aqueous solvent and an electrolyte salt dissolved in the non-aqueous solvent. The non-aqueous electrolyte is not limited to a liquid electrolyte, but may be a solid electrolyte prepared using a gel polymer or the like.

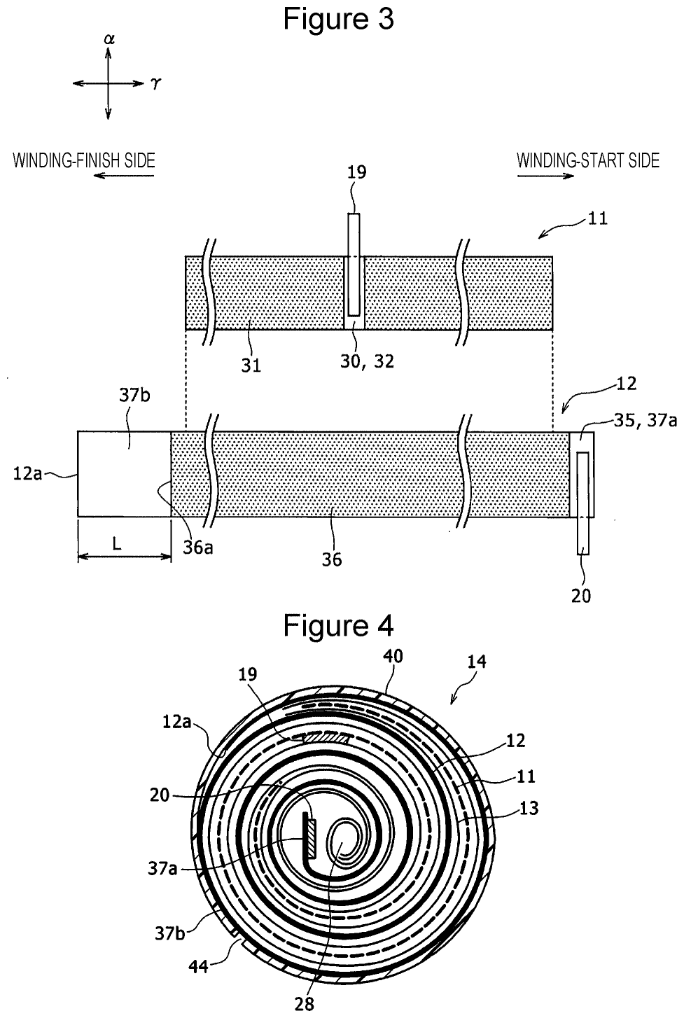

The positive electrode plate 11 includes a belt-shaped positive electrode current collector 30, for example, formed of aluminum alloy foil or the like (refer to FIG. 3) and a positive electrode lead 19 bonded to the current collector 30. The positive electrode lead 19 is a conductive member for electrically connecting the positive electrode current collector 30 to a positive electrode terminal of the non-aqueous electrolyte secondary battery 10 and extends beyond an upper end of an electrode group in the axial direction α (toward the upper side) of the electrode body 14. Here, the term “electrode group” refers to the portion of the electrode body 14 other than leads. The positive electrode lead 19 is provided, for example, in an approximately central portion in the radial direction β of the electrode body 14.

The negative electrode plate 12 includes a belt-shaped negative electrode current collector 35, for example, formed of copper foil (refer to FIG. 3) and a negative electrode lead 20 connected to the current collector. The negative electrode lead 20 is a conductive member for electrically connecting the negative electrode current collector 35 to a negative electrode terminal of the non-aqueous electrolyte secondary battery 10 and extends beyond a lower end of the electrode group in the axial direction α (toward the lower side). For example, the negative electrode lead 20 is provided in a winding-start end portion arranged at the inner end in the radial direction of the electrode body 14. Hereinafter, the inner peripheral side of the electrode body 14 may be referred to as the winding core side, and the outer peripheral side may be referred to as the winding outer side in some cases.

The positive electrode lead 19 and the negative electrode lead 20 are each a belt-shaped conductive member having a thickness larger than that of the current collector. The thickness of the lead is, for example, 3 to 30 times the thickness of the current collector and is generally 50 μm to 500 μm. Although a constituent material of each lead is not particularly limited, the positive electrode lead 19 is preferably formed of a metal containing aluminum as a main component, and the negative electrode lead 20 is preferably formed of a metal containing nickel or copper as a main component. In addition, the number of leads, the arrangement thereof, and the like are not particularly limited.

In the example shown in FIG. 1, a case main body 15 and a sealing body 16 constitute a battery case made of metal that receives the electrode body 14 and the non-aqueous electrolyte. Insulating plates 17 and 18 are provided on the upper side and the lower side of the electrode body 14, respectively. The positive electrode lead 19 extends through a through-hole of the insulating plate 17 to the sealing body 16 side and is welded to a lower surface of a filter 22 which is a bottom plate of the sealing body 16. In the non-aqueous electrolyte secondary battery 10, a cap 26 which is a top plate of the sealing body 16 electrically connected to the filter 22 serves as a positive electrode terminal. On the other hand, the negative electrode lead 20 extends through a through-hole of the insulating plate 18 to the bottom side of the case main body 15 and is welded to an inner surface of the bottom of the case main body 15. In the non-aqueous electrolyte secondary battery 10, the case main body 15 serves as a negative electrode terminal.

As described above, the electrode body 14 has a winding structure in which the positive electrode plate 11 and the negative electrode plate 12 are spirally wound with the separator 13 interposed therebetween. The positive electrode plate 11, the negative electrode plate 12, and the separator 13, each formed in a belt shape, are spirally wound so as to be alternately stacked in the radial direction β of the electrode body 14. In the electrode body 14, the longitudinal direction of each of the electrodes is a winding direction γ, and the width direction of each of the electrode plates 11 and 12 is the axial direction α. In this embodiment, a space 28 is formed in the winding core of the electrode body 14.

The case main body 15 is a cylindrical container made of metal having a bottom. A gasket 27 is provided between the case main body 15 and the sealing body 16 so that airtightness in the battery case can be secured. The case main body 15 has a protruding portion 21 which is formed, for example, by pressing a side surface portion from the outside and which supports the sealing body 16. The protruding portion 21 is preferably formed in an annular shape along the circumferential direction of the case main body 15, and the upper surface thereof supports the sealing body 16.

The sealing body 16 includes the filter 22, a lower valve body 23, an insulating member 24, an upper valve body 25, and the cap 26 which are stacked in this order from the electrode body 14 side. The individual members constituting the sealing body 16 have, for example, a circular plate shape or a ring shape, and the members other than the insulating member 24 are electrically connected to one another. The lower valve body 23 and the upper valve body 25 are connected to each other at the central portions thereof, and the insulating member 24 is interposed between the peripheral portions of the lower valve body 23 and the upper valve body 25. When the internal pressure of the battery increases due to abnormal heat generation, for example, the lower valve body 23 is broken, and consequently, the upper valve body 25 is expanded to the cap 26 side and is separated from the lower valve body 23, resulting in disconnection of electrical connection between the valve bodies. When the internal pressure further increases, the upper valve body 25 is broken, and a gas is exhausted from an opening 26a of the cap 26.

FIG. 3 is a front view showing the positive electrode plate 11 and the negative electrode plate 12 constituting the electrode body 14, each in an unwound state. In FIG. 3, the right side of the page corresponds to the winding-start side of the electrode body 14, and the left side of the page corresponds to the winding-finish side of the electrode body 14. Furthermore, FIG. 4 is a cross-sectional view in the radial direction showing the state in which the electrode body 14 is fixed with a tape 40. In FIG. 4, in order to facilitate seeing, the positive electrode plate 11, the negative electrode plate 12, and the separator 13 are illustrated with spaces interposed therebetween. However, actually, these members are wound closely.

As illustrated in FIG. 3, in the electrode body 14, in order to prevent precipitation of lithium on the negative electrode plate 12, the negative electrode plate 12 is formed such that the width in the axial direction α is larger than that of the positive electrode plate 11 and the length in the winding direction γ is larger than that of the positive electrode plate 11. At least a portion of the positive electrode plate 11 at which a positive electrode active material layer 31 is formed is arranged so as to face a portion of the negative electrode plate 12 at which a negative electrode active material layer 36 is formed with the separator 13 interposed therebetween.

The positive electrode plate 11 includes a belt-shaped positive electrode current collector 30 and a positive electrode active material layer 31 formed on the current collector. In this embodiment, the positive electrode active material layer 31 is formed on each of both surfaces of the positive electrode current collector 30. As the positive electrode current collector 30, for example, a foil of a metal such as aluminum, a film in which the metal is disposed as a surface layer, or the like is used. Preferably, the positive electrode current collector 30 is a foil of a metal containing aluminum or an aluminum alloy as a main component. The thickness of the positive electrode current collector 30 is, for example, 10 μm to 30 μm.

The positive electrode active material layer 31 is preferably formed over the entire region of each of both surfaces of the positive electrode current collector 30 except a positive electrode current collector exposed portion 32, which will be described later. The positive electrode active material layer 31 preferably contains a positive electrode active material, a conductive agent, and a binder. The positive electrode plate 11 can be formed by applying a positive electrode mixture slurry containing a positive electrode active material, a conductive agent, a binder, and a solvent, such as N-methyl-2-pyrrolidone (NMP), onto both surfaces of the positive electrode current collector 30, and drying and compressing the resulting coating films.

Examples of the positive electrode active material include a lithium transition metal oxide containing a transition metal element, such as Co, Mn, or Ni. The lithium transition metal oxide is not particularly limited, but is preferably a composite oxide represented by the general formula Li₁₊ₓMO₂ (in the formula, −0.2<x≤0.2, and M represents at least one of Ni, Co, Mn, and Al).

Examples of the conductive agent include carbon materials, such as carbon black (CB), acetylene black (AB), Ketjen black, and graphite. Examples of the binder include fluorine-based resins, such as polytetrafluoroethylene (PTFE) and polyvinylidene fluoride (PVdF), polyacrylonitrile (PAN), polyimide (PI), acrylic resins, and polyolefin resins. Furthermore, these resins may be used together with carboxymethyl cellulose (CMC) or a salt thereof, polyethylene oxide (PEO), or the like. These resins may be used alone or in combination of two or more.

The positive electrode plate 11 has a positive electrode current collector exposed portion 32. The positive electrode current collector exposed portion 32 is a portion to which the positive electrode lead 19 is connected and is a portion in which the surface of the positive electrode current collector 30 is not covered with the positive electrode active material layer 31 and the positive electrode current collector 30 is exposed. The positive electrode current collector exposed portion 32 is formed wider than the positive electrode lead 19. Preferably, positive electrode current collector exposed portions 32 are provided on both surfaces of the positive electrode plate 11 so as to overlap in the thickness direction of the positive electrode plate 11.

In the example shown in FIG. 3, at the central portion in the longitudinal direction of the positive electrode plate 11, the positive electrode current collector exposed portion 32 is provided over the entire width of the positive electrode plate 11. Although the positive electrode current collector exposed portion 32 may be formed at a position closer to the end portion in the longitudinal direction of the positive electrode plate 11, from the viewpoint of the current-collecting property, the positive electrode current collector exposed portion 32 is preferably provided at a position approximately equidistant from the two ends in the longitudinal direction. The positive electrode current collector exposed portion 32 is provided, for example, by intermittent application in which the positive electrode mixture slurry is not applied onto a part of the positive electrode current collector 30. In addition, the positive electrode current collector exposed portion 32 may be provided with a length that does not to extend from one end in the width direction of the positive electrode plate 11 to the other end.

The negative electrode plate 12 includes a belt-shaped negative electrode current collector 35 and a negative electrode active material layer 36 formed on the negative electrode current collector 35. In this embodiment, the negative electrode active material layer 36 is formed on each of both surfaces of the negative electrode current collector 35. As the negative electrode current collector 35, for example, a foil of a metal such as copper, a film in which the metal is disposed as a surface layer, or the like is used. The thickness of the negative electrode current collector 35 is preferably small in order to increase the capacity of the non-aqueous electrolyte secondary battery 10, and for example, is preferably 7 μm or more and 10 μm or less.

The negative electrode active material layer 36 is preferably formed over the entire region of each of both surfaces of the negative electrode current collector 35 except both end portions in the longitudinal direction. The negative electrode active material layer 36 preferably contains a negative electrode active material and a binder. The negative electrode plate 12 can be formed by applying a negative electrode mixture slurry containing, for example, a negative electrode active material, a binder, and water or the like onto both surfaces of the negative electrode current collector 35, and drying and compressing the resulting coating films.

The negative electrode active material is not particularly limited as long as it can reversibly occlude and release lithium ions. For example, a carbon material such as natural graphite or artificial graphite, a metal such as silicon or tin that forms an alloy with lithium, an alloy containing such a metal, or a composite oxide can be used. The type of graphite or the form of silicon oxide contained in the negative electrode active material is not particularly limited.

In order to increase the capacity of the non-aqueous electrolyte secondary battery 10, preferably, the negative electrode active material contains at least one silicon material selected from silicon, silicon oxide, and lithium silicate. Since the silicon material undergoes a large change in volume during charging and discharging, in order to suppress cracking of the negative electrode active material layer 36, the silicon material is preferably used by mixing with a carbon material. For example, the content of the silicon material in the negative electrode active material is preferably 3% by mass or more and 20% by mass or less, and more preferably 5% by mass or more and 10% by mass or less.

As the binder contained in the negative electrode active material layer 36, for example, a resin similar to that used in the positive electrode plate 11 may be used. In the case where the negative electrode mixture slurry is prepared using an aqueous solvent, styrene-butadiene rubber (SBR), CMC or a salt thereof, polyacrylic acid or a salt thereof, polyvinyl alcohol, or the like can be used. These may be used alone or in combination of two or more.

The negative electrode plate 12 has a negative electrode current collector exposed portion 37a at the winding-start end portion thereof. The negative electrode current collector exposed portion 37a is a portion to which the negative electrode lead 20 is connected and is a portion in which each of both surfaces of the negative electrode current collector 35 is not covered with the negative electrode active material layer 36 and the negative electrode current collector 35 is exposed. The negative electrode current collector exposed portion 37a is provided, for example, by intermittent application in which the negative electrode mixture slurry is not applied onto a part of the negative electrode current collector 35.

The negative electrode current collector exposed portion 37a has an approximately rectangular shape extending along the width direction of the negative electrode plate 12 and is formed wider than the negative electrode lead 20 along the length direction of the negative electrode plate 12. Preferably, negative electrode current collector exposed portions 37a are provided on both surfaces of the negative electrode plate 12. The negative electrode lead 20 is arranged such that one end portion thereof is located on the negative electrode current collector exposed portion 37a and the other end portion thereof extends beyond a lower end of the negative electrode current collector exposed portion 37a. The negative electrode lead 20 is, for example, bonded by ultrasonic welding to the negative electrode current collector exposed portion 37a.

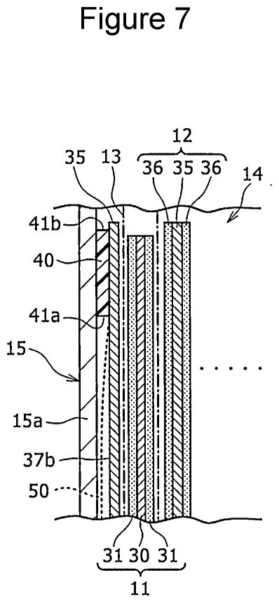

The negative electrode plate 12 has a negative electrode current collector exposed portion 37b at the winding-finish end portion thereof. The negative electrode current collector exposed portion 37b is a portion in which each of both surfaces of the negative electrode current collector 35 is not covered with the negative electrode active material layer 36 and the negative electrode current collector 35 is exposed. As shown in FIG. 4, the negative electrode current collector exposed portion 37b is a portion constituting an outermost periphery of the electrode body 14 when spirally wound together with the positive electrode plate 11 and the separator 13. When the outermost periphery of the electrode body 14 is constituted by the negative electrode current collector exposed portion 37b in this way, in the case where the electrode body 14 is received inside the case main body 15, the negative electrode current collector exposed portion 37b can be brought into electrical contact with the inner surface of a case sidewall 15a (refer to FIG. 7). As a result, it is possible to omit to attach a negative electrode lead to the winding-finish end portion of the negative electrode plate 12.

As shown in FIG. 3, preferably, the length L in the winding direction γ of the negative electrode current collector exposed portion 37b is set at a length constituting the entire outermost periphery of the electrode body 14. However, the length L of the negative electrode current collector exposed portion 37b is not limited thereto and may be set such that winding is performed in a state in which an end 36a on the winding-finish side of the negative electrode active material layer 36 projects out to the outermost periphery of the electrode body 14. The negative electrode current collector exposed portions 37b may have different lengths between the front and back sides of the negative electrode plate 12. Furthermore, the negative electrode plate current collector exposed portion 37b can be provided only on a surface on the winding outer side of the negative electrode plate 12. In such a case, the length L of the negative electrode current collector exposed portion 37b is determined on the basis of the length of the negative electrode current collector exposed portion 37b on the winding outer side of the negative electrode plate 12.

As the separator 13, a porous sheet having ion permeability and an insulating property is used. Specific examples of the porous sheet include a microporous thin film, woven fabric, and non-woven fabric. As the material for the separator 13, an olefin resin, such as polyethylene or polypropylene, is preferable. The thickness of the separator 13 is, for example, 10 μm to 50 μm. The thickness of the separator 13 tends to be decreased with an increase in capacity and an increase in output of the battery. The separator 13, for example, has a melting point of about 130° C. to 180° C.

As shown in FIG. 4, after the positive electrode plate 11 and the negative electrode plate 12 are spirally wound with the separator 13 interposed therebetween, the winding-finish end portion is fixed by attaching a tape 40 to the outermost periphery. In this way, winding looseness of the electrode body 14 can be prevented. In this embodiment, preferably, the tape 40 is attached, approximately one circle, around the outermost periphery of the electrode body 14. Hence, when the electrode body 14 is inserted into the case main body 15, the negative electrode current collector exposed portion 37b at the outermost periphery can be prevented from being turned up. In this embodiment, there is, for example, a slight gap 44 of about 1 mm between the two ends of the tape 40.

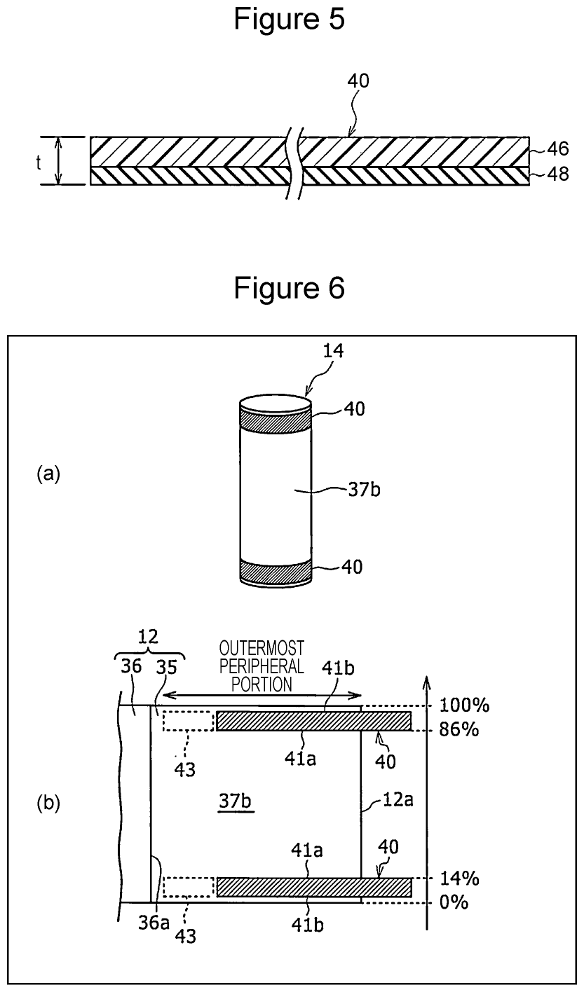

FIG. 5 is an enlarged cross-sectional view of a tape 40. As illustrated in FIG. 5, the tape 40 includes a base material layer 46 and an adhesive layer 48. The base material layer 46 is preferably formed of a resin material having excellent insulating property and electrolyte resistance. In this embodiment, the main component of the base material layer 46 is preferably polypropylene (PP). However, the base material layer 46 may be formed of another resin material, for example, an ester resin such as polyethylene terephthalate (PET), polyimide (PI), polyethylene (PE), polyphenylene sulfide (PPS), or the like. These resin materials may be used alone or in combination of two or more.

The adhesive layer 48 is preferably formed using an adhesive having excellent insulating property and electrolyte resistance. Although the adhesive constituting the adhesive layer 48 may be either a hot-melt type adhesive which exhibits adhesion by heating or a thermosetting type adhesive which is cured by heating, an adhesive having adhesion at room temperature is preferable from the viewpoint of productivity and the like. The adhesive layer 48 is formed, for example, using an acrylic adhesive or a synthetic rubber-based adhesive.

The thickness t of the tape 40 including the base material layer 46 and the adhesive layer 48 is preferably small in order to suppress cracking of the negative electrode active material layer, which will be described later. However, in order to secure fixing strength for preventing winding looseness, the tape 40 preferably has a certain thickness or more. For example, the thickness t is preferably 8 μm or more and 40 μm or less, and more preferably 12 μm or more and 30 μm or less.

The width of the tape 40 can be set appropriately so that the inner edge of the tape 40 is located at a position within 14% from the end in the axial direction of the negative electrode plate 12, as will be described later. However, in order to prevent the negative electrode current collector exposed portion from being turned up, the tape 40 preferably has a certain width or more, and for example, the width is preferably 3 mm or more and 7 mm or less.

FIG. 6(a) is a perspective view of an electrode body, and FIG. 6(b) is a diagram showing a winding-finish end of a negative electrode plate and tapes, each in an unwound state. In the electrode body 14 according to this embodiment, each of the tapes 40 is attached to a region located within 14% of the length in the axial direction of the negative electrode plate 12 from a corresponding one of the two ends in the axial direction of the negative electrode plate 12.

More specifically, as shown in FIG. 6(a), in the electrode body 14 according to this embodiment, the winding-finish end 12a of the electrode body 14 is fixed with the belt-shaped tapes 40 at both ends in the axial direction. In FIG. 6(b), the attachment positions of the tapes 40 are shown based on the coordinate in the axial direction in which the lower end of the negative electrode plate 12 is set at 0% and the upper end of the negative electrode plate 12 is set at 100%. The tape 40 attached to the lower end portion of the electrode body 14 is attached such that the inner edge 41a thereof is located at a position 14% from the lower end of the negative electrode plate 12. Furthermore, the tape 40 attached to upper end portion of the electrode body 14 is attached such that the inner edge 41a thereof is located at a position 86% from the lower end of the negative electrode plate 12 (i.e., at a position 14% from the upper end). Here, the inner edge 41a of the tape 40 refers to an edge located on the central side in the axial direction of the negative electrode plate 12, and the edge on the opposite side is referred to as an outer edge 41b.

In this embodiment, the tapes 40 are attached such that, for example, a margin of about 1 mm is formed between each of the outer edges 41b and the lower end of the negative electrode plate 12 or the upper end of the negative electrode plate 12. In this way, the tapes 40 can be prevented from projecting from the negative electrode plate 12 and being attached over the adjacent separator 13. However, without providing such margins, the tapes 40 may be attached such that the outer edges 41b of the tapes 40 correspond to the lower end and the upper end of the negative electrode plate 12.

As shown in FIG. 6(b), the tapes 40 extend beyond the winding-finish end 12a of the negative electrode plate 12, and the extending portions thereof are attached to rectangular regions indicated by broken lines 43 of the negative electrode current collector exposed portion 37b constituting the outermost periphery of the electrode body 14. In this way, the tapes 40 are attached, approximately one circle, around the outer periphery of the electrode body 14, and the winding-finish end 12a is fixed. As a result, winding looseness of the positive electrode plate 11, the negative electrode plate 12, and the separator 13 constituting the electrode body 14 can be prevented.

FIG. 7 is an enlarged cross-sectional view of a tape fixed portion in an electrode body 14 received inside a case main body 15. In FIG. 7, a gap between a negative electrode current collector exposed portion 37b constituting the outermost periphery of the electrode body 14 and a case sidewall 15a of the case main body 15 is illustrated in an exaggerated manner. However, actually, since the thickness of the tape 40 is sufficiently small, the tape 40 does not hamper stable contact between the negative electrode current collector exposed portion 37b and the case sidewall 15a.

The electrode body 14 having the structure described above is received inside the case main body 15, thus forming a non-aqueous electrolyte secondary battery 10. When the non-aqueous electrolyte secondary battery 10 repeats charging and discharging, the electrode body 14 expands and contracts repeatedly. In particular, during charging, since the negative electrode active material layer 36 having a relatively high expansion coefficient expands, the diameter of the electrode body 14 increases. At this time, the electrode body 14 swells outward in the radial direction as indicated by the broken line 50 in FIG. 7, and the amount of swelling tends to increase toward the central portion in the axial direction of the electrode body 14.

At each end portion in the axial direction of the electrode body 14, since the tape 40 is attached by being wound therearound, a restraint force that limits swelling of the electrode body 14 is generated. Accordingly, at a position corresponding to the inner edge 41a of the tape 40, stress that acts on the positive electrode plate 11 and the negative electrode plate 12 increases intensively. This stress, similarly to the swelling force of the electrode body 14, increases as the inner edge 41a of the tape 40 moves toward the central side in the axial direction of the electrode body 14.

Due to the stress repeatedly acting, there is a possibility that cracking will occur in the negative electrode active material layer 36 of the negative electrode plate 12 located closer to the inner peripheral side than the negative electrode current collector exposed portion 37b. In such a case, because of exposure of the negative electrode current collector 35 at the cracked portion, there is a concern that metallic lithium may be precipitated.

Accordingly, in the non-aqueous electrolyte secondary battery 10 according to this embodiment, the region to which each of the tapes 40 is attached in the negative electrode current collector exposed portion 37b at the outermost periphery is set to a region located within 14% of the length in the axial direction of the negative electrode plate 12 from a corresponding one of the two ends in the axial direction of the negative electrode plate 12. By attaching the tape 40 to such a region, at a position corresponding the inner edge 41a of the tape 40, the stress acting on the negative electrode active material layer 36 relatively decreases. Therefore, it is possible to effectively suppress cracking of the negative electrode active material layer 36 at the position corresponding to the inner edge 41a of the tape 40.

### EXAMPLES

The present disclosure will be further described below on the basis of examples. However, it is to be understood that the present disclosure is not limited to the examples.

### Example 1

[Formation of Positive Electrode Plate]

A positive electrode mixture slurry was prepared by mixing 100 parts by mass of a lithium transition metal oxide represented by LiNi_{0.88}Co_{0.09}Al_{0.03}O₂ serving as a positive electrode active material, 1 part by mass of acetylene black, and 0.9 parts by mass of polyvinylidene fluoride serving as a binder, and further adding thereto an appropriate amount of N-methyl-2-pyrrolidone (NMP). Next, the positive electrode mixture slurry was applied onto both surfaces of a positive electrode current collector formed of aluminum foil, and the resulting coating films were dried. The current collector provided with the coating films was rolled by using a roller, and then cut into a predetermined electrode size. A positive electrode lead formed of aluminum was ultrasonically welded to a positive electrode current collector exposed portion provided at a central portion in the longitudinal direction, thereby forming a positive electrode plate.

[Formation of Negative Electrode Plate]

A negative electrode mixture slurry was prepared by mixing 95 parts by mass of graphite powder, 5 parts by mass of silicon oxide (SiO), 1 part by mass of carboxymethyl cellulose (CMC) serving as a thickener, and 1 part by mass of styrene-butadiene rubber (SBR) dispersed liquid serving as a binder, and further adding thereto an appropriate amount of water. Next, the negative electrode mixture slurry was applied onto both surfaces of a negative electrode current collector formed of copper foil, and the resulting coating films were dried. The current collector provided with the coating films was rolled by using a roller, and then cut into a predetermined electrode size. A negative electrode lead was ultrasonically welded to a negative electrode current collector exposed portion provided at a winding-start end portion, thereby forming a negative electrode plate.

[Formation of Electrode Body]

The positive electrode plate and the negative electrode plate were wound with a separator formed of a polyethylene porous film interposed therebetween. At the outermost periphery, tapes having a base material layer formed of polypropylene with a width of 7 mm and a thickness of 30 μm were attached to a negative electrode current collector exposed portion such that, as shown in FIG. 6, the inner edge of each of the tapes was located at a position 14% of the length in the axial direction of the negative electrode plate from a corresponding one of the two ends in the axial direction of the negative electrode plate, thereby forming an electrode body. In this case, the entire outermost periphery of the electrode body was formed of the negative electrode current collector exposed portion.

[Preparation of Non-Aqueous Electrolyte]

A non-aqueous electrolyte was prepared by adding 5 parts by mass of vinylene carbonate (VC) to 100 parts by mass of a mixed solvent in which ethylene carbonate (EC) and dimethyl methyl carbonate (DMC) were mixed at a volume ratio of 1:3, and dissolving therein LiPF₆ at a concentration of 1.5 mol/L.

[Fabrication of Secondary Battery]

Insulating plates were arranged on the upper side and the lower side of the electrode body, the negative electrode lead of the electrode body was welded to the bottom of a case main body, the positive electrode lead of the electrode body was welded to a filter of a sealing body, and the electrode body was received in the case main body. Then, the non-aqueous electrolyte was poured into the case main body. Lastly, an opening of the case main body was covered with the sealing body, thereby fabricating a non-aqueous electrolyte secondary battery. The secondary battery had a capacity of 4,600 mAh.

### Example 2

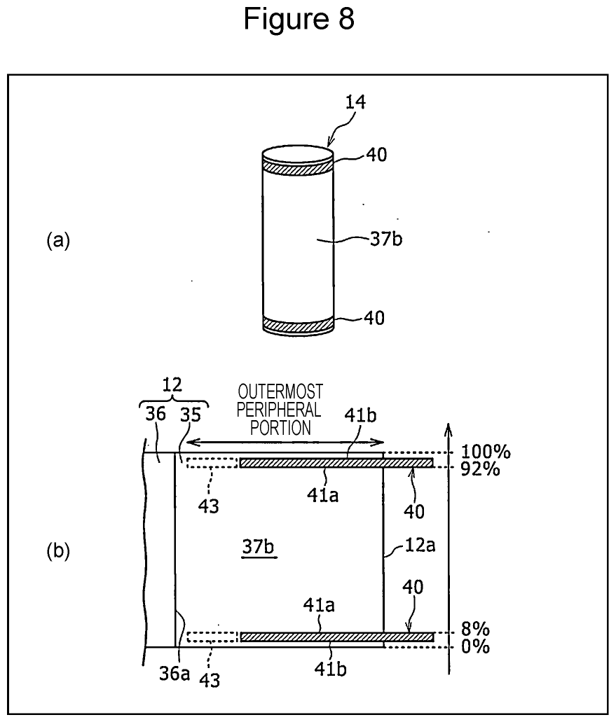

A non-aqueous electrolyte secondary battery was fabricated as in Example 1, except that, after the positive electrode plate and the negative electrode plate were wound with a separator formed of a polyethylene porous film interposed therebetween, at two ends in the axial direction, tapes having a base material layer formed of polypropylene with a width of 3 mm and a thickness of 30 μm were attached to a negative electrode current collector exposed portion such that, as shown in FIG. 8, the inner edge of each of the tapes was located at a position 8% of the length in the axial direction of the negative electrode plate from a corresponding one of the two ends in the axial direction of the negative electrode plate, thereby forming an electrode body.

### Comparative Example

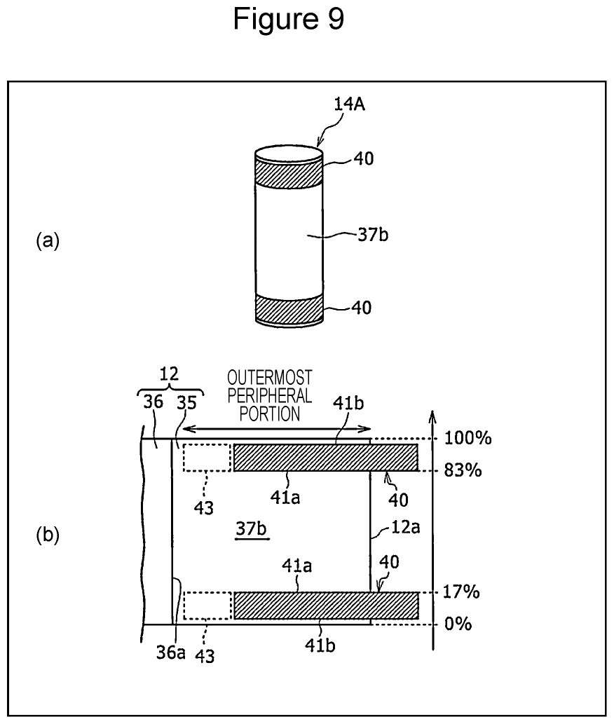

A non-aqueous electrolyte secondary battery was fabricated as in Example 1, except that, after the positive electrode plate and the negative electrode plate were wound with a separator formed of a polyethylene porous film interposed therebetween, at two ends in the axial direction, tapes having a base material layer formed of polypropylene with a width of 9 mm and a thickness of 30 μm were attached to a negative electrode current collector exposed portion such that, as shown in FIG. 9, the inner edge of each of the tapes was located at a position 17% of the length in the axial direction of the negative electrode plate from a corresponding one of the two ends in the axial direction of the negative electrode plate, thereby forming an electrode body (14A).

[Evaluation and Data]

Under the conditions described below, a charge/discharge cycle test was conducted on each of the non-aqueous electrolyte secondary batteries of Example 1, Example 2, and Comparative Example. After the test, occurrence of cracking of the negative electrode active material layer of the negative electrode plate in the electrode body was checked.

[Charge/Discharge Conditions]

In an environment of 25° C., constant current charging was performed at 1,380 mA (0.3 hour rate) until the voltage reached 4.2 V, then constant voltage charging was performed at 4.2 V with a termination current of 92 mA, and after resting for 20 minutes, constant current discharging was performed at a discharge current of 4,600 mA (1 hour rate), followed by resting for 20 minutes. This process was defined as one charge/discharge cycle, and 500 cycles were repeated.

The evaluation results are shown in Table 1.

TABLE 1

| | Position | | Occurrence of cracking of |
|---|---|---|---|
| | of inner edge | | negative electrode active |
| | of tape | Tape width | material layer |
| Example 1 | 14% | 7 mm | Not occurred |
| Example 2 | 8% | 3 mm | Not occurred |
| Comparative | 17% | 9 mm | Occurred |
| Example | | | |

As shown in Table 1, in Examples 1 and 2, cracking of the negative electrode active material layer did not occur. However, in Comparative Example, cracking of the negative electrode active material layer occurred. This confirms that the inner edge of each of the tapes should be located at a position within 14% of the length in the axial direction of the negative electrode plate from a corresponding one of the two ends of the negative electrode plate.

It is to be understood that the non-aqueous electrolyte secondary battery according to the present disclosure is not limited to the above-described embodiments and modified examples thereof, and various changes and improvements can be made without departing from the spirit of the claims and within the scope equivalent to that of the claims.

### REFERENCE SIGNS LIST

10 non-aqueous electrolyte secondary battery
11 positive electrode plate
12 negative electrode plate
13 separator
14 electrode body
15 case main body
16 sealing body
17, 18 insulating plate
19 positive electrode lead
20 negative electrode lead
21 protruding portion
22 filter
23 lower valve body
24 insulating member
25 upper valve body
26 cap
27 gasket
28 space
30 positive electrode current collector
31 positive electrode active material layer
32 positive electrode current collector exposed portion
35 negative electrode current collector
36 negative electrode active material layer
37a, 37b negative electrode current collector exposed portion
40 tape
41a inner edge
41b outer edge
46 base material layer
48 adhesive layer

1. A non-aqueous electrolyte secondary battery comprising:
an electrode body in which a positive electrode plate including a belt-shaped positive electrode current collector and a positive electrode active material layer formed on a surface of the positive electrode current collector and a negative electrode plate including a belt-shaped negative electrode current collector and a negative electrode active material layer formed on a surface of the negative electrode current collector are wound with an insulating separator interposed therebetween,
wherein, at the outermost periphery of the electrode body, a negative electrode current collector exposed portion, in which the negative electrode current collector is exposed, is provided, and a winding-finish end of the negative electrode plate is fixed with tapes attached to the negative electrode current collector exposed portion; and
wherein each of the tapes is attached to a region located within 14% of the length in the axial direction of the negative electrode plate from a corresponding one of the two ends in the axial direction of the negative electrode plate.

2. The non-aqueous electrolyte secondary battery according to claim 1, wherein each of the tapes includes a base material layer and an adhesive layer, and the base material layer contains polypropylene as a main component.

3. The non-aqueous electrolyte secondary battery according to claim 1, wherein each of the tapes has a thickness of 8 μm or more and 40 μm or less.

4. The non-aqueous electrolyte secondary battery according to claim 1, wherein the negative electrode active material layer contains, as a negative electrode active material, a carbon material and a silicon material, and the content of the silicon material in the negative electrode active material is 3% by mass or more and 20% by mass or less.
